(19) United States
(12) Patent Application Publication
(10) Pub. No.: US 2008/0021953 A1
(43) Pub. Date: Jan. 24, 2008

(54) Method and System for Automatically Connecting Real-World Entities Directly to Corresponding Network-Based Data Sources or Services

(76) Inventor: Jacob Gil, Hadera (IL)

Correspondence Address: Mark M. Friedman;c/o Polkinghorn, 9003 Florin Way, Upper Marlboro, MD, 20772, US

(21) Appl. No.: 10/593,339

(22) PCT Filed: Aug. 23, 2001
(86) PCT No.: PCT/US01/26330

§ 371 Date: Sep. 19, 2006

Related U.S. Application Data
(60) Provisional application No. 60/227,308, filed on Aug. 24, 2000.

(51) Int. Cl. G06F 15/16

(52) U.S. Cl. 709/203

(57) ABSTRACT

A system and method for enabling the use of real-world objects (16), data segments or information segments as direct links to network based information, knowledge, services and data sources. The system comprises a communications device (10) with an input mechanism for capturing data from a real world object (16), connecting the device (10) to a network server (12) in order to search for a related online source for the object, transferring the information to the device (10), or providing the service to the device or the user. Alternatively, the present invention enables connecting the real world object (16) data to an online link, or initiate a predefined action, either automatically or manually.

### FIELD AND BACKGROUND OF THE INVENTION

### BACKGROUND OF THE INVENTION

1. Field of the Invention

The present invention relates to an improved method and system for searching for and interacting with network-based information sources or any connectable information sources (CIS) and services, by using real-world elements as links to that information, or as triggers for system actions.

2. Description of the Related Art

One of the primary functions that the Internet and other connectable info sources enable is the provision of massive, varied, global information sources and services. Typical means of connecting users to such information sources and services, for purposes such as researching subject matter, executing transactions or contacting companies/individuals etc. entail connecting the user of an Internet compatible device to a specific Web site or page where the relevant information is found. This is usually initiated by typing an address, clicking on a hyperlink or using a search engine for search purposes. In order to find relevant information it is typically necessary for a user to use text-based means, such as typing in the name or keywords of an object.

Alternative means have also been developed to enable navigation and searching using voice recognition technology. The increasing use of the VoiceXML standard, which combines the Extensible Markup Language (XML) with advanced voice recognition, providing interactive access to the Internet via phone or voice browsers. Following a collaboration of AT&T, IBM, Lucent Technologies and Motorola, VoiceXML was adopted in March 2000as a way to “voice enable” Internet applications, by the World Wide Web Consortium standards group. Voice navigation systems enable navigation of elements or objects by speaking them, but this still does not enable the usage of the objects themselves in the searching procedure.

The search for improved information searching techniques has lead to the development of various technologies that enable the usage of the real world elements/objects themselves to activate the information searches. AirClick (5 Valley Square Park, Suite 200, 512 Township Line Road, Blue Bell, Pa 19422, USA, http://www.airclic.com/), for example, can connect the user to a web site by scanning a bar code, such that a user is not requires to type in any data in order to initiate an accurate search. Another company, WuliWeb Inc. (1265 Birchwood Drive, Sunnyvale, Calif., 94089-2206, USA—www.WuliWeb.com) enables the user to type the numbers that are printed above a bar code and than be connected to the relevant web page. These technologies, however, are limited in their applicability to bar-coded objects.

Thcre is thus a widely recognizud need for, and it would be highly advantageous to have, a system and method that can enable the automatic linking of a variety of real world elements and objects to online information sources and services for the purposes of research, communication, security or commerce.

### SUMMARY OF INVENTION

According to the present invention there is provided a system for enabling the use of real-world objects or elements (including data/information segments) as direct links (hyperlinks) to network based information, services or commercial sources.

Specifically, the present invention enables a network (including Internet or alternative connectable information source (hereinafter referred to as “CIS”)) enabled device with data-acquisition capabilities (including camera, scanner, sound recorder, smeller device, sensor etc.), to connect real-world elements or objects directly to corresponding Web sites, CIS or services related to the objects. The connection is initiated, either by the user or is automatically triggered by the device.

The following expressions, referred to hereinafter, include the following classifications:
CIS Any “Connectable Information Source”, such as the Internet, intranets, extranets, the World Wide Web and dedicated networks.
Network: A system that transmits any combination of voice, video and/or alternative data between users. This includes the Internet, Intranets, Extranets and all other data networks, wherein data is shared, stored, queried, processed or transferred between network elements.
Network elements: Include databases, routers, servers, switches, bridges, client devices, host devices etc.
Network Server: A server that includes functions of Web servers, Intranet servers, network access servers and any other CIS that enable information processing and client requests to be processed and served.
Network enabled: Any device or machine that has a communications component enabling connectivity to a data network, such that the device can communicate data to and from the network.
Real World Elements: Any objects or data segmnents that may be sensed by humans or alternative sensor mechanisms.
   The present invention is comprised of:
   i. At least one network enabled device for capturing real world object's data and communicating with a network;
   ii. Device (Client) software for processing and enabling interacting with the object's data;
   iii. A network server system for processing requests from the network enabled devices and other network elements; and
   iv. Any kind of information, data, or knowledge database for storing links to information sources or services, or actual information or services.

The process according to which the present invention operates, comprises the steps of:

i. Capturing data from the real world—by taking a sample in, using a (client) network-enabled device;

ii. Optionally, initial processing of that data within the device;

iii. Connecting the user device to a network server or dedicated server, in order to enable matching up of the object's data, representation or description to a related information or service source; and

iv. Transferring the object related data or service to the device, for viewing, hearing, sensing, buying or otherwise utilizing the information.

V. Optionally, initiating an action, such as a request, emergency call, telephone call, transaction, alerting the user etc.

### BRIEF DESCRIPTION OF THE DRAWINGS

The invention is herein described, by way of example only, with reference to the accompanying drawings, wherein:

FIG. 1 is an illustration of the components and basic operations according to the present invention.

FIG. 2 illustrates an example of a cellular phone graphical user interface.

### DESCRIPTION OF THE PREFERRED EMBODIMENT

The present invention, hereinafter referred to as the “object connector system”, relates to a system and method for enabling the use of real-world objects or elements (data segments (such as an object's bitmap, pieces of music) or information segments (such as electromagnetic radiation—Radio broadcast)) as direct links (such as hyperlinks) to information, knowledge, service provider and data sources (such as the Internet, World Wide Web, extranets, service centers etc.).

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention enables an Internet or CIS enabled device (wireless/cellular phone, NetPhone, PDA, portable computer, pager, computer, digital camera etc.) with data-acquisition capabilities (such as a camera, scanner, sound recorder, smeller device, probe, etc.), optionally computational capability (CPU, software), a connection (wireless or wireline) to information (such as the Internet, telephone directory) and a Man-Machine interface (MMI) for providing an interface to enable connecting real-world objects directly to their corresponding network-based information or service sites.

An example of such as system is an Internet enabled cellular phone equipped with a camera. The user can point the camera at an object, take a photograph of the object, and then press a key to send this bitmap image to a server for further processing/research. Alternatively, the device itself may undertake initial processing of the object data, and than send the result of the processing to the Web server. The user is then connected to a Web page (or a list of hyperlinks) which includes that specific photograph or relevant information about it.

The object connector system is enabled to capture data from any source, and make use of the data according to its specific type, such as searching of dedicated sound, taste, smell, audio or graphic-based databases, including the following:

| | |
|---|---|
| SEEING | images, graphics, movement, video |
| HEARING | sounds, music, voices |
| SMELLING | smells |
| FEELING | feel, touch |
| TASTING | tastes |
| SENSING | waves, energy, forces, time |

The object connector system can also capture information that our senses cannot capture, such as:

Electromagnetic radiation, ultrasound, radio waves, slow changes (movement of clock hands), vibrations (pre-earthquake), low-heat sources and undersound (sound at frequencies which are lower than human hearing capability: <18 Hz). These various information sources may be utilized by the object connector system, by employing a communications/computing device with an appropriate input mechanism for the relevant information source. Subsequently, the information is captured, optionally processed, and transferred via the device to a network server for further research etc.

The object connector system can be integrated into a device (e.g. cellular phone, PDA) that is network-enabled and that incorporates a sensor (e.g. camera, microphone etc.). Any other internet-enabled devices with any kind of sensor can also be utilized for the purpose of the present invention.

The object connector system captures information (data) from the real world (e.g. an image) using the sensor (e.g. camera), and subsequently links to a database (or search engine in order to find a reference to this data on a relevant network based source. For example, an image based search engine can screen a visual database to find this specific image, subject, item or service on a paricuiar Web page.

The object connector system of the present invention can optionally perform some analysis on the object or image within the device itself, such as capturing text, performing Optical Character Recognition (OCR) and using this added information to enable more accurate searching (e.g. identify the web address that appears on an advertisement as added information). OCR is well known in tile art and is in commonly used in online dictionaries (such as Babylon, from Babylon Ltd., 10 Hataasiya Street, Or-Yehuda, Israel, 60212), offline dictionaries (such as quicktionary, from Quick-Pen.com, from Kansas City, Mo. 64145-1247), scanners etc.

The object connector system can optionally use extra information that the cellular phone system can provide, such as geographical location by triangulation or by GPS to locate the cellular phone, and incorporate it into the other data acquired. The object connector system can also use extra information from other sources, such as temperature, humidity and movement, and perform data-fusion to support and focus the basic data segment to enhance its relevancy in locating the relevant web page, database or service. It is possible for a user to predefine conditions or rules (such as, when I arrive in city X, remind me to visit aunt Sara) that will act as triggers for device's actions. In this case, the device acts together with information passively received (such as location, weather, moods, smells, sounds etc.) to initiate a pre-configured request or alert.

An additional example of the application of the object connector system is the case where the user aims his or her phone at a hotel's name (Logo), captures it and automatically gets connected to the hotel chain's reservation office. The cellular phone system can automatically add the user's actual location information (e.g. 5th av. on 55th St.), and the hotel's reservation system will send the user the specific information about the actual hotel that he or she is now looking at. The device (for example a cellular phone) can subsequently be connected to the actual Web page of this hotel reception-desk. The user can then look at the information, study it, analyze it and decide what to do with it (choose a room, request for more information, check special offers, make an order, etc.).

The object connector system can then connect the device (for example a cellular phone) to a Web site (or a list of hyperlinks to information sources, search tools etc.) and display the relevant information to the user (on a screen, vocally etc.). The user can then look at the information, study it, analyze it and decide what to do with it (such as buy an item, get store information, go there etc.).

### DETAILED DESCRIPTION OF THE PARTS

The present invention consists of:

i. At least one network enabled device 10 for capturing real world object data and communicating with a network;

ii. Client software in said device, for enabling interacting with the object data and optionally processing the object data;

iii. A network server system 12 for processing requests from the network enabled devices and other network-based elements; and

iv. Any kind of information, data, or knowledge database 14 for storing links to network based information sources or services (such as databases, search engines and connections to service providers, including Police, security company, emergency services, etc.), or actual data sources.

1. The device includes:

i. At least one sensor, or data capturing mechanism (such as a camera, scanner, smeller mechanism, microphone, antenna, taster mechanism, feeler mechanism, IR sensor, geophone (which is an electronic receiver designed to pick up seismic vibrations), radiation meter, movement meter, acceleration meter, wind meter, thermometer, humidity sensor etc.

ii. A communications mechanism for enabling data transfer between the device and a network, including wireless/wireline access to the Internet, Intranet or other information sources).

2. The device's (client) software includes:

i. Man-Machine Interface (MMI), providing features such as menus, emergency buttons, audio interaction, voice recognition (to choose menu items, etc.) for enabling user interaction with the data;

ii. Optionally data processing and storage capabilities (image capture, image compaction, OCR, etc.). These capabilities enable the data to be captured and optionally processed and stored. Such capabilities enable, for example, the device to optionally execute additional processing of the object data, such as filtering the data (for example, discerning a URL on an advertisement) or adding relevant alternative factors (for example, the users current geographic location);

iii. Optionally, a local engine/database to undertake local research on the captured object, so as to maximize search accuracy and efficiency. This processing engine can search within the device in:

1 User preference lists, or instruction lists which are stored in the device's memory;
2 The device's memory for previous searches; and
3 Other devices memory options, such as telephone lists, events, documents, photos.
   The client software enables the user to:
   i. Enable capturing of the data, through the sensor or sensors.
   ii. Optionally, to add instructions and extra information (i.e. tell the search engine to look for the data in a specialized database, such as searching for an image in the logos database by typing or saying “logo”).
   iii. Process the data and incorporate relevant factors such as weather conditions, timing, geography, topography, events, history, user's mood, user's vital parameters (such as heartbeat, breathing, temperature). This processing may additionally incorporate relevant items from the memory of the device.
   iv. send raw or processed data to a remote information center (web server etc.)
   v. store information for later use.

It is noted that the location of the software and hardware modules of the object connecting system can differ from one implementation to another.

3. The Network server svstem includes:

i. A communications center for receiving and serving data to and from system users; and

ii. a processing component for processing and serving requests.

4. The data source includes:

i. At least one database for storing links to object-related data, or the data itself. This database may optionally include at least one specialized search engine (e.g. Image/smell/taste/sound/feeling based searches using pattern matching) for enabling searches of network-based data related to captured object. This a user may be linked to data found in sources such as Web sites, intranet sites, extranet sites, databases, search engines, and service centers, or may access the data directly from the primary data source. The database may include fields such as:

a] Web site links to links to other sites or information sources;

b] Other optional databases, including: Image, sound, smell, feel, speech based databases; and

c] User preferences and details, client responses; security codes etc.

d] Other means of connection (telephony, wireless etc.).

In an alternative embodiment, the device can connect itself directly to the target (e.g. a web page) by self-performing some processing (OCR) that generates an address (URL).

Detailed Description of the Process According to the Present Invention

The “object connector system” achieves this connection in using the following steps:
1. Capture data from the real world—take a sample in using a client network-enabled device, either through initiation by the user, or through an automated process by the device itself.
   2. Optionally, initial processing of that data within the device.
   3. Connecting the client device to a network server or a dedicated server (may include Web server, Intranet server, Service provider server etc.), via a data network, in order to match the object's data representation or description with related data sources or services online.
   4. Get the object-related data or service from the relevant online source, and transfer it to the device for viewing, buying or otherwise utilizing. After the connection is achieved, interactive searching is enabled, including studying, analyzing, seeing, hearing, smelling, feeling and tasting of the object-related data

The getting of this data optionally includes accessing and interaction with this data from the (client) device itself.

5. Optionally, automatic or user initiating of at least one pre-configured action, such as an emergency call, alert, transaction, alarm etc.

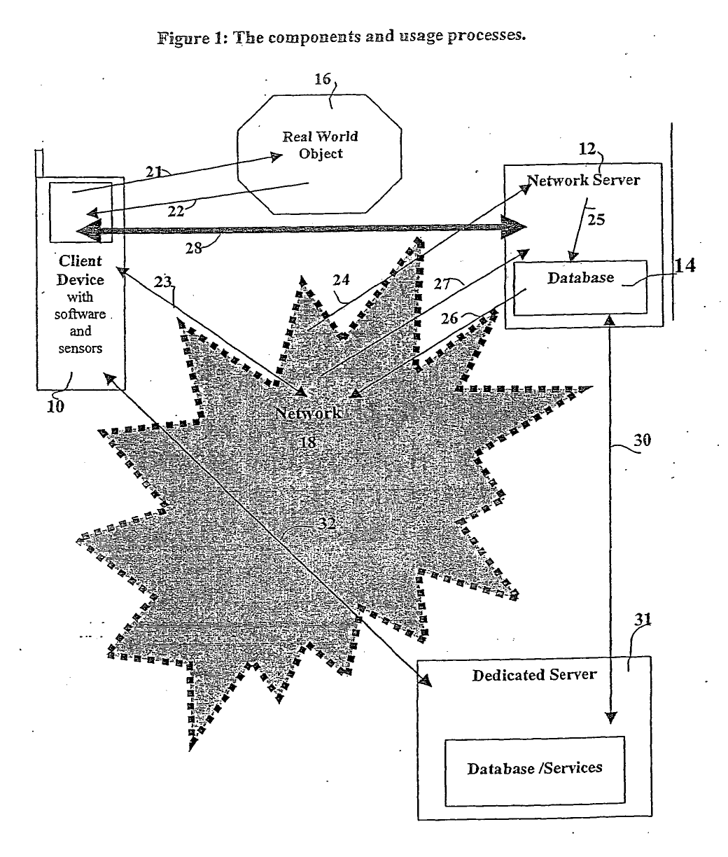

As can be seen in FIG. 1:

i. A client device 10 is instructed to view/hear/smell/touches/sense/feel 21 a real world object 16, and subsequently to choose or capture the real world object data. Alternatively, the device may be configured to automatic receive the data without user initiation, such as receiving geographic data based on the device's current location.

ii. The data of the object 16 is captured 22 and optionally processed by the device 10.

iii. If not processed by the device 10, the device 10 sends 23 the object data or processed data to the Network server 12, in the form of a request. The request is sent via the Internet 18 or any other data network.

Alternatively, the device can alternatively connect itself directly 30 to an external (dedicated) information source, as in the case where some processing occurs in the device (such as OCR online), or if the link already exists in the device memory. In these cases, the device 10 sends 32 the data to a dedicated server 31, via a dedicated connection. An example of this is a security company that has placed dedicated “red buttons” (for emergency alerts) on client devices. Upon pressing the button, a user may be connected directly to the dedicated server of the company, powered by the object connector system, which will serve the request.

iv. The Network Server 12 receives the request 24 from the Internet 18 and queries 25 the relevant local database/information source 14 for appropriate information or links. If the required information is found in this local data source, the information is sent back to the device 28.

v. If a request requires linking to a network 18 (such as the World Wide Web) or another external data source or service provider, the device 10 or the database 14 sends a request 23, 26 to the network-based 18, information source or service provider, such as a Web site, search engine, or to a dedicated information or service provider, via a dedicated server 31.

vi. The information or service source 18 responds to the request, sending 27 the data to the server 12 or directly to the device 23. In the case where the information request was processed by the dedicated server 31, the response is similarly sent either back to the Network Server 12 or directly to the Device 32.

vii. In the case where the data is sent to the Server 12, the server 12 subsequently sends 28 the data to the device 10.

viii. The device 10 receives the data, and the user subsequently reads/smells/views/listens to/tastes/feels the data. The user can thereby surf the CISs and initiate subsequent requests at will.

The above method can be described as follows:

The aim of the present invention is to transform a piece of raw sensor data (such as bitmap data) into a database (DB) address (i.e. a URL) or to initiate an action (alarm, reminder). In this example, there are at least three ways of executing the process:

1. One on one match (using pattern matching (pattern recognition)) of the data (i.e. bitmap) to the data base data, and from there to extract the address; or

2. Extract a minimal amount of data from the bitmap that suffices to identify the image in order to establish an address, referred to as minimizing. This may entail a process of reducing resolution of the image in order to minmize data transfer, while retaining enough clarity in order to create a viable pointer (until it is the smallest, viable pointer). For example, if the database contains 100 information objects, than a bitmap resolution of 10×10 may suffice, in order to establish a viable pointer to at least one one of the above mentioned information objects.

3. Introduce data-fusion techniques to incorporate additional information to the sensor data, such as performing Optical Character Recognition (OCR) on a newspaper advertisement. This process thereby focuses the match of the sensed data to the relevant database, in order to identify a URL address in a more specialized area. An example is using GPS technology or using the cellular service provider's information about the device's location, such that a geographical component is added to the captured image, and the subsequent matching of the object to the database and the URL link incorporates the geographical limitation.

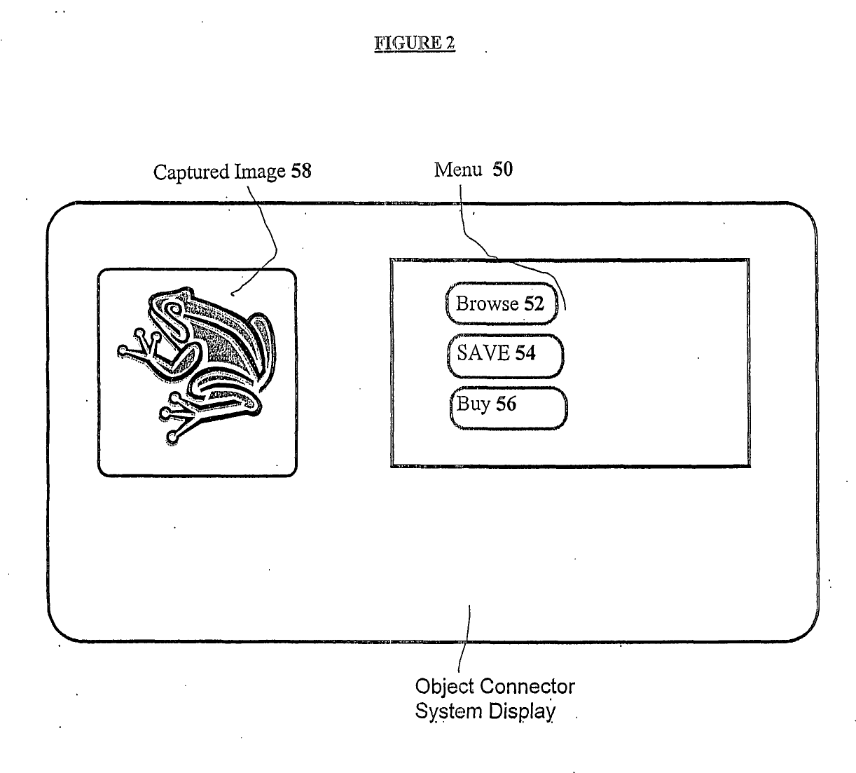

An example of a graphic user interface according to the present invention can be seen with reference to FIG. 2: As can be seen in the figure, the graphic user interface of the device may present the user with relevant search options, such as menu 50 with options to learn more or browse 52, save the data 54 or buy 56 the captured object 58. The menu 50 may be customized according to the type of data able to be captured. For example, a device with a smeller mechanism (sniffer) may provide options to learn, smell, mix and buy.

In a preferred embodiment of the present invention, there is provided a network enabled device with an integrated camera (or scanner), such as: cellular telephone, NetPhone, PDA, Portable computer, personal computer, pager, Internet enabled appliance, gadget or machine. The present device is constructed using existing components such as mobile devices with scanning means, smelling means, picture/video capture means, audio capture means, touch sensitive means and taste sensitive means.

In an additional embodiment of the present invention, the object data captured or utilized by the client device can be stored for later use, such as studying it later or transferring it to another device (a PC, PDA, computerized-refrigerator, etc.).

In a still father embodiment of the present invention, the client software enables an application that automatically alerts the user, based on geographical, topographical, time-related, and situation related factors. For example, the device that captured the object data can be configured to automatically respond to certain events, such as send a warning signal to the user when sensing higher than average radiation, alerting the user to unusual climaate or odors, sending the user alerts based on geographical location etc. These actions or events may be pre-stored in the device memory or in a remote database, accessible to the device.

### EXAMPLE 1

A person aims his or her digital camera (with network connectivity facility) at an object (car, printed advertisement) and takes its photograph. The camera captures the image and displays it on the screen. The user chooses a part or all of the image, presses a button and gets connected to a network server that connects the user device to a relevant database. This database either answers the request or refers the request to an external database, Web site or search engine, that searches the web for this specific image (using pattern matching, minimizing, reducing resolution and data-fusion. etc.). Once the user is connected to an information source, such as a Web page or a list of hyperlinks, he or she can navigate there, study the information and get connected to other relevant sources.

The user can then use all the Internet facilities such as e-Commerce, navigational information, purchasing and reservation systems etc. The user can also compare prices, contact dealers and purchase the object that he or she saw.

### EXAMPLE 2

The user can point a cellular telephone device, which is powered with the client software of the present invention, at an object, take a digital photograph of the object, and immediately be connected to a corresponding Web page that includes the captured photograph and/or information about the photograph. Such a cellular telephone is an Internet enabled cellular telephone equipped with a digital camera, which enables the capture and usage of real world objects (such as an image of a flower or an advertisement) or data segments (such as pieces of music) or information segments (such as electromagnetic radiation, radio broadcasts) as direct links (such as hyperlinks) to information, knowledge and data sources (such as the Web, Internet, extranets, intranets etc.). The user can subsequently execute fiulther research, initiate transactions, process requests, or alternatively store the image and information for later use.

### EXAMPLE 3

The user can aim his or her cellular phone (with a camera function) at an advertisement billboard near the highway, capture the picture and get connected to the relevant dealer or web page (using location information that is acquired from the cellular service provider).

### EXAMPLE 4

In an emergency situation (rubbery etc.), the users pushes a chosen button (the “red button”) on his or her cellular phone, and:

i. A picture is taken of the offender;

ii. The phone connects to an emergency call center (police) and sends the bit map image and the geographical location of the incident, and continually transfers voice and photographs to this center.

### EXAMPLE 5

Accident sensor that responds to accident parameters (shock, noise, rotation) and automatically contacts an emergency center.

### EXAMPLE 6

Outdoor personal alarm (LR, volume, movement sensor) that alarms the user about an approaching intruder.

### EXAMPLE 7

An improved personal “emergency button” for asthmatics (Keeps in its memory typical asthmatic sounds and responds by contacting emergency services or automatically initiating a reminder to the user upon identifying such sounds; and heart patients (monitor relevant parameter/s and respond accordingly).

### EXAMPLE 8

A military or a security services provider device, such as device for guards or soldiers, wherein:

i. The guard clicks upon arrival at predefined station to monitor his/her job performance. Each click sends a signal (photo, geographic location) to the company's control center to monitor the guard's performance.

ii. In case of emergency (an intruder), the guard presses a “red button” that sends an alarm, a photo of the intruder, guard voice and a sound recording to the control center. The device continues data transfer thereafter.

iii. Optional: A virtual Guard:

The Guard (soldier) leaves the device in a particular place. The device is programmed to respond to predefined signals and to send the data back to the center.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for automatically connecting real world entities to corresponding network based information sources, comprising:
i. at least one network enabled device for capturing real world object data and communicating with a network;
ii. client software for said device, for enabling interaction with said object data;
iii. a network server system to process requests from said device and other network-based elements; and
iv. at least one information source for providing data responses to requests from said network server system.

2. The system of claim 1, wherein said device further comprises:
a. data-acquisition mechanism for capturing real world object data;
b. a communications mechanism for enabling transfer between said device and a network; and
c. a man-machine interface for enabling user interaction with said data.

3. The system of claim 2, wherein said data-acquisition mechanism includes a sensor mechanism selected from the group consisting of a microphone, scanner, smeller mechanism, taster mechanism, feeler mechanism, antenna, IR sensor, geophone, radiation meter, movement meter, acceleration meter, wind meter, thermometer and humidity sensor.

4. The system of claim 2, wherein said communications mechanism is selected from the group consisting of wireless and wireline communications mechanisms.

5. The system of claim 1, wherein said client software includes a computational mechanism for processing said data.

6. The system of claim 5, further comprising a local information source, for providing information for said computational mechanism.

7. The system of claim 1, wherein said network server system is a dedicated server for providing responses to client requests.

8. The system of claim 1, wherein said information source comprises at least one kind of data selected from the group consisting of audio, textual, olfactory, taste, touch, radiation, movement and time-change data.

9. A method for automatically connecting real world elements to network based information sources relating to the elements, comprising:
i. capturing data from a real world element, by a network-enabled device with a data input mechanism;
ii. connecting said device to a server, for matching said real world element to a corresponding information source on a network; and
iii. delivering data from said information source to said device.

10. The method of claim 9, wherein step i. further comprises processing said data.

11. The method of claim 9, wherein said step iii. includes interacting with said information source from said device.

12. The method of claim 9, further comprising automatic initiation of at least one pre-configured action.

13. The method of claim 9, wherein said information source is selected from the group consisting of a Web site, intranet site, extranet site, database, search engine, dedicated server and service center.

14. The method of claim 9, wherein said information source provides data selected from the group consisting of textual, visual, multimedia, olfactory, touchable, audio data, electromagnetic radiation, ultrasound, vibrations, undersound, radiation, and time-change data.

15. A method for automatically connecting real world element data to network-based data source, comprising:
i. capturing a real world object, by a client device;
ii. sending said object data to a server, in the form of a request;
iii. querying a relevant database for corresponding information for said request; and
iv. sending requested data to said device.

16. The method of claim 15, wherein step i. further comprises processes said data by said device, before sending to said server, such that said real world object data is pre-filtered before executing said querying of a database.

17. The method of claim 16, wherein said processing uses a mechanism selected from the group consisting of pattern matching, minimizing, reducing resolution and data-fusion.

18. The method of claim 15, wherein said step iii. further comprises linking to an external information source to search for information relevant to said request.

19. The method of claim 15, further comprising automatically initiating an action in said client device.
